(19) United States
(12) Patent Application Publication
(10) Pub. No.: US 2024/0213763 A1
(43) Pub. Date: Jun. 27, 2024

(54) METHOD AND CONTROL UNIT FOR OPERATING A SWITCH DEVICE HAVING A SWITCH UNIT, AND SWITCH DEVICE

(71) Applicant: ZF Friedrichshafen AG, Friedrichshafen (DE)

(72) Inventors: Marc Rasch, Immenstaad (DE); Sebastian Besold, Neudrossenfeld (DE)

(73) Assignee: ZF Friedrichshafen AG, Friedrichshafen (DE)

(21) Appl. No.: 18/391,001

(22) Filed: Dec. 20, 2023

(30) Foreign Application Priority Data
Dec. 22, 2022 (DE) 102022214264.0

(51) Int. Cl. H02H 7/122; H02H 7/22; H02M 1/00; H02M 1/32; H02M 1/36

(52) U.S. Cl. CPC H02H 7/1225; H02H 7/222; H02M 1/0009; H02M 1/327; H02M 1/36; B60L 15/007

(57) ABSTRACT

A switch device includes a switch unit which has first and second connections, a control connection, and multiple switches connected between the first and second connection and which are jointly activated or activatable by the control connection. A method comprises reading a measurement signal via an interface into a measuring unit, wherein the measurement signal represents an actual parameter of the switch unit, determining a fault state of the switch unit if the actual parameter is in a predetermined relationship with a predefined target parameter, and providing a fault protection signal in response to the determined fault state, wherein the fault protection signal is configured to activate at least one fault protection switch and thereby apply a protection signal to the control connection, by which the switches are closed or kept closed.

### CROSS-REFERENCE TO RELATED APPLICATION

This application claims priority to German Application No. 10 2022 214 264.0, filed on Dec. 22, 2022, the entirety of which is hereby fully incorporated by reference herein.

### FIELD

The present disclosure relates to a method and a control unit for operating a switch device having a switch unit, and to a switch device according to the preamble of the main claims.

### BACKGROUND

Power converters are generally usable in a multiplicity of domains, inter alia, for example, in power supply, in motor control or, for example, in the energy transmission domain. Power converters normally have switches in order to be able to map a phase change.

### SUMMARY

Against this background, the present disclosure provides an improved method and an improved control unit for operating a switch device having a switch unit, and an improved switch device. Advantageous embodiments can be found in the following description.

The approach presented here provides a facility for controlled activation of a switch device which can preferably be used for a vehicle, even in the event of a fault and therefore in the event of impeded activatability, at least until, for example, an emergency function of the vehicle can be activated and the vehicle can therefore, for example, be transferred safely to a stationary state.

A method is presented for operating a switch device having a switch unit which has a first connection, a second connection, a control connection and a multiplicity of switches connected between the first connection and the second connection which are jointly activated or activatable by the control connection. The method comprises a step of reading a measurement signal via an interface into a measuring unit, wherein the measurement signal represents an actual parameter of the switch unit. The method further comprises a step of determining a fault state of the switch unit if the actual parameter is in a predetermined relationship with a predefined target parameter, and a step of providing a fault protection signal in response to the determined fault state, wherein the fault protection signal is designed to activate at least one fault protection switch and thereby apply a protection signal to the control connection, by which the switches are closed or kept closed.

The switch device can be implemented, for example, as part of a power converter which is used, for example, for or in a vehicle. The switch device can have, for example, the switch unit, the first connection of which, in the case where the switch is designed as a semiconductor, in particular as a MOSFET switch, can also be referred to as the drain, while the second connection can be referred to as the source and the control connection as the gate. The switch unit preferably has more than two switches which can be connected in parallel and can therefore all be activated, for example, simultaneously by the control connection. This means that the switches can advantageously respond in the same manner after being activated. The measuring unit can be implemented, for example, as a voltmeter, an ammeter or as a temperature meter which can measure a corresponding existing value as an actual parameter. The fault state determined through the use thereof can indicate, for example, a defective switch from the plurality of switches which, for example, can no longer correctly close. In order to be able to prevent overheating or overloading of the other switches and therefore a defect in further components of the switch device or even in the power converter, the further switches from the plurality of switches can advantageously be kept closed so that, for example, a current is not concentrated in the event of a fault on the single, defective switch, but can be distributed among all switches and the switch unit can function as a passive electrical conductor.

According to one embodiment, in the step of reading in as an actual parameter, a voltage between the first and second connection can be read in and, in the determining step, the fault state can be determined if the voltage is less than a predefined target voltage. Additionally or alternatively, in the step of reading in as an actual parameter, a current can be read in by the first connection and, in the determining step, the fault state can be determined if the current is greater than a predefined target current. Furthermore, in the read-in step, a parameter representing at least a temperature of one of the switches can be read in additionally or alternatively as an actual parameter, and, in the determining step, the fault state can be determined if the temperature is greater than a predefined target temperature. Advantageously, the voltage, the current and, additionally or alternatively, the temperature of the switch unit can accordingly be continuously monitored and, for example, a defect in a multiplicity of components of the power converter, such as, for example, further switch devices having further switch units, can therefore be prevented in real time. In other words, this means that damage limitation can advantageously be carried out at an early stage.

Furthermore, in the providing step, the fault protection signal can be provided to a semiconductor switch between the first connection and the control connection in order to be able to close the semiconductor switch in the fault state. The fault protection switch can therefore be implemented, for example, as a semiconductor switch so that the voltage present on the first connection can advantageously be applied to the control connection. A fast and simple activation of the switches in the event of a fault can be achieved in this manner.

In the providing step, the fault protection signal can be provided to a support switch between the control connection and an energy source coupled to the second connection. The activation of the support switch can have the effect that a capacitance of the energy source maintains a voltage value that is present at the control connection continuously above a limit value and therefore keeps the switches of the switch unit closed, thereby preventing the switch unit or the individual switches from switching to a toggle mode as a result of temporarily falling below the limit value.

According to one embodiment, in the providing step, the fault protection signal can be provided to a voltage predefinition switch between the control connection and an intermediate tapping point of a voltage divider connected between the first and second connection. The fault protection switch can therefore be implemented, for example, as a voltage predefinition switch which can be closed in a determined fault state and can be kept closed, for example, in order to be able to apply an electrical voltage present at the intermediate tapping point to the control connection.

Furthermore, in the providing step, the fault protection signal can be provided to the voltage predefinition switch, wherein the voltage predefinition switch can further be connected between the control connection and a connection point. The energy source can be connected between the connection point and the second connection. Here also, the fault protection switch can be implemented as a voltage predefinition switch. Since, for example, at least one voltage divider having the highest possible impedance in order to achieve the lowest possible energy loss can be connected between the first and the second connection, an electrical voltage can advantageously be kept stable using the energy source, and a sudden, substantial drop in a voltage value at the control connection or at the connection point can therefore be prevented.

According to one embodiment, in the providing step, the fault protection signal can be superimposed on the control connection and, additionally or alternatively, impressed on the control connection, wherein the control connection can be designed in order to be able to activate a switching procedure of the switches of the switch unit in a normal operating state. This means that the fault protection signal can advantageously be superimposed on a normal operating signal if the fault state has been determined. As a result, on one hand, an already present control connection can advantageously continue to be used, and the switch unit can likewise be prevented from reverting to the normal operating state in order to prevent damage to further components of the power converter.

The approach presented here further provides a control unit which is designed to carry out, activate or implement the steps of a variant of a method presented here in corresponding devices. An object on which the present disclosure is based can be quickly and efficiently achieved through this design variant of the present disclosure in the form of a control unit also.

A control unit can be an electrical device which processes electrical signals, for example sensor signals, and outputs control signals depending thereon. The device can have one or more suitable interfaces which can be designed on a hardware and/or software basis. In the case of a hardware-based design, the interfaces can, for example, be part of an integrated circuit in which functions of the control unit are implemented. The interfaces can also comprise their own integrated circuits or can consist at least partially of discrete components. In the case of a software-based design, the interfaces can be software modules which are present, for example, on a microcontroller along with other software modules.

Also advantageous is a computer program product having program code which can be stored on a machine-readable medium such as a semiconductor memory, a hard disk memory or an optical memory and is used to carry out the method according to one of the embodiments described above when the program is executed on a computer or a control unit.

A switch device having a switch unit and a control unit in a previously mentioned variant is further presented, wherein the switch unit has a first connection, a second connection, a control connection and a plurality of switches which are connected between the first connection and the second connection and are jointly activated by the control connection. The control unit is designed to activate the control connection of the switches of the switch unit with the fault protection signal.

The switch device can be implemented, for example, as a component for a power converter. The switch device can have the control unit in a previously mentioned variant.

According to one embodiment, the switches of the switch unit can be designed as power electronic components, in particular as semiconductor switching elements. Semiconductor switching elements of this type can advantageously be implemented as metal oxide semiconductor field effect transistors (MOSFET), as insulated gate bipolar transistors (IGBT) or, for example, as thyristors.

The present disclosure also relates to a power converter, in particular an inverter, for a motor vehicle having a switch device. The power converter is characterized in that the switch device is designed as described. In particular, the power converter can have a plurality of switch devices.

The present disclosure also relates to an electrical final drive for a motor vehicle having at least an electric machine, a drive device and power converter. The electrical final drive is characterized in that the power converter is designed as described.

The drive device can have a drive for reducing the rotational speed of the electric machine, and a differential.

The present disclosure also relates to a motor vehicle having an electrical final drive and/or a power converter. The motor vehicle is characterized in that the electrical final drive and/or the power conductor is/are designed as described. The approach presented here can be implemented quickly and efficiently in these embodiments also.

The present disclosure is explained in detail by way of example with reference to the attached drawings.

### BRIEF DESCRIPTION OF THE DRAWINGS

FIG. 1 shows a schematic view of a motor vehicle according to one exemplary embodiment;

FIG. 2 shows a schematic view of an exemplary embodiment of a final drive for a motor vehicle;

FIG. 3 shows a schematic view of a switch device according to one exemplary embodiment;

FIG. 4 shows a schematic view of an exemplary embodiment of a circuit for a switch unit;

FIG. 5 shows a schematic view of an exemplary embodiment of a further circuit for a switch unit;

FIG. 6 shows a schematic view of an exemplary embodiment of a further circuit for a switch unit having an energy source;

FIG. 7 shows a schematic view of an exemplary embodiment of a further circuit for a switch unit having at least one voltage divider;

FIG. 8 shows a schematic view of an exemplary embodiment of a further circuit for a switch unit having at least one voltage divider and an energy source; and

FIG. 9 shows a flow diagram of an exemplary embodiment of a method for operating a switch device having a switch unit.

### DETAILED DESCRIPTION

In the following description of preferred exemplary embodiments of the present disclosure, the same or similar reference signs are used for the elements which are shown in the different figures and have similar effects, wherein these elements not described repeatedly.

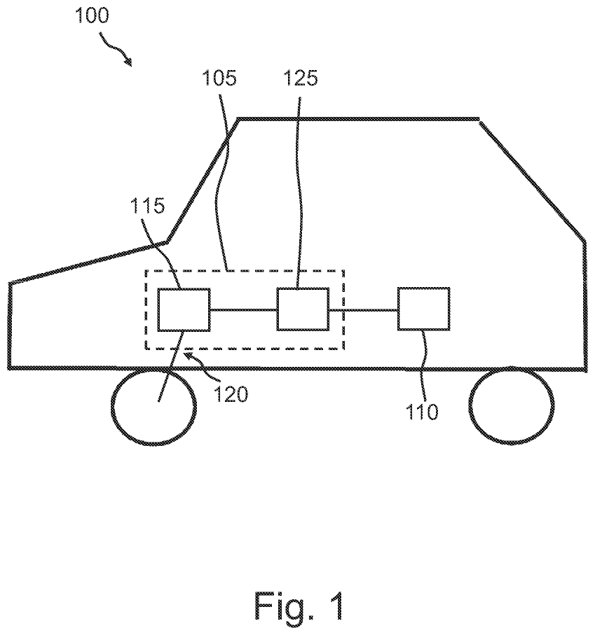

FIG. 1 shows a schematic view of a motor vehicle 100 according to one exemplary embodiment. The motor vehicle 100 is described below simply as the vehicle 100 and is designed, for example, for transporting persons and/or objects. The vehicle 100 has an electrical final drive 105 and, for example, an energy supply device 110 which can be designed, for example, as an accumulator or as a fuel cell. The final drive 105 in turn has an electric machine 115, for example an electric motor, and a drive device 120 and a power converter 125. The power converter 125 is implemented or implementable as an inverter and has at least one switch device as described in detail in at least one of the following figures.

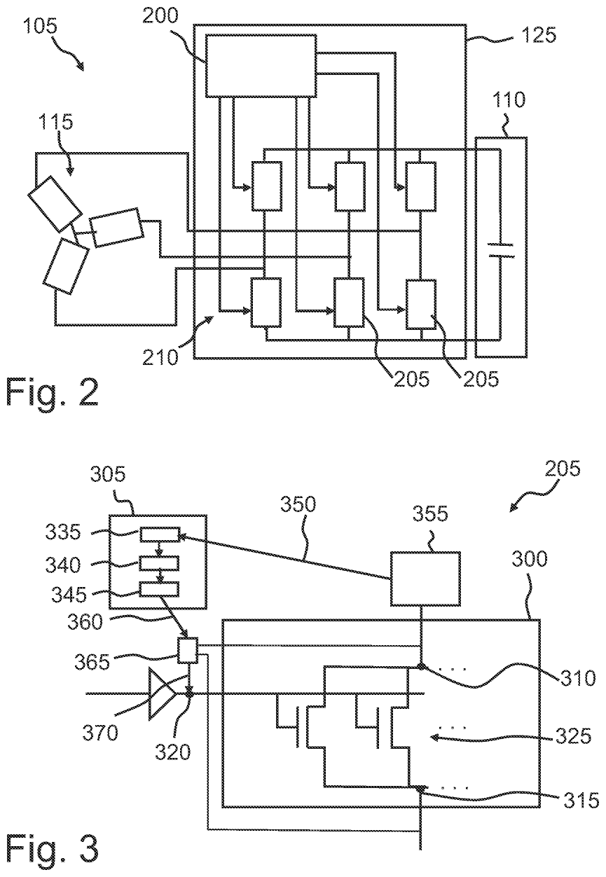

FIG. 2 shows a schematic view of an exemplary embodiment of a final drive 105 for a motor vehicle. The final drive 105 is similar, for example, to the final drive 105 shown in FIG. 1 and is shown in simplified form according to this exemplary embodiment. The power converter 125 rather than the drive device is shown in detail here. According to this exemplary embodiment, the power converter 125 has a control device 200 and a plurality of switch devices 205. The control device 200 is designed to activate the switch devices 205 and to operate the power converter 125 accordingly. This means that the control device 200 is electrically connected to each individual of the switch devices 205 and the switch devices 205 are electrically connected to the electric machine 115. The power converter 125 is further coupled to the energy supply device 110 by electrical lines 210 so that the electric machine 115 is supplied with electricity. Different electrical lines 210 are used for the power supply depending on which of the switch devices 205 is activated. A specific temporal activation of the opening or closing of the individual switch devices 205 is also known in electrical drive technology as a bridge rectifier activation and will not be described in detail here in the interests of providing a brief description of the approach presented here.

FIG. 3 shows a schematic view of a switch device 205 according to one exemplary embodiment. The switch device 205 has a switch unit 300 and a control unit 305. The switch unit 300 further has a first connection 310, a second connection 315 and a control connection 320. The first connection 310 is also referred to, for example, as the drain connection, the second connection 315 as the source connection and the control connection 320 as the gate connection if the switches shown in FIG. 3 are designed as MOSFET switches. The control unit 300 further has a plurality of switches 325 which are connected between the first connection 310 and the second connection 315, are of identical design and are connected in parallel. The switches 325 are further activated, for example, by the common control connection 320. The switches 325 are therefore designed, for example, as power electronics components, for example as semiconductor switches, such as those used, for example, for metal oxide semiconductor field effect transistors (MOSFET), for insulated gate electrode bipolar transistors (IGBT) or, for example, for thyristors. According to this exemplary embodiment, the switch unit 300 is shown, by way of example, with two identically designed switches 325. Alternatively, it is conceivable for the switch unit 302 additionally to have further switches 325 also.

The control unit 305 is designed to activate and/or carry out a method for operating a switch device 205. The method is described in detail in FIG. 9. The control unit 305 has a read-in unit 335, a determining unit 340 and a providing unit 345 for this purpose. The read-in unit 335 is designed to read a measurement signal 350 via an interface into a measuring unit 355, wherein the measurement signal 350 represents an actual parameter of the switch unit 300. The determining unit 340 is designed to determine a fault state of the switch unit 300 if the actual parameter is in a predetermined relationship with a predefined target parameter.

The providing unit 345 is designed to determine a fault protection signal 360 in response to the determined fault state, wherein the fault protection signal 360 is designed to activate at least one fault protection switch 365 and thereby apply a protection signal 370 to the control connection 320, by which the switches 325 are closed or kept closed. This is appropriate, for example, if, for example, one of the switches 325 is defective and, for example, no longer opens completely.

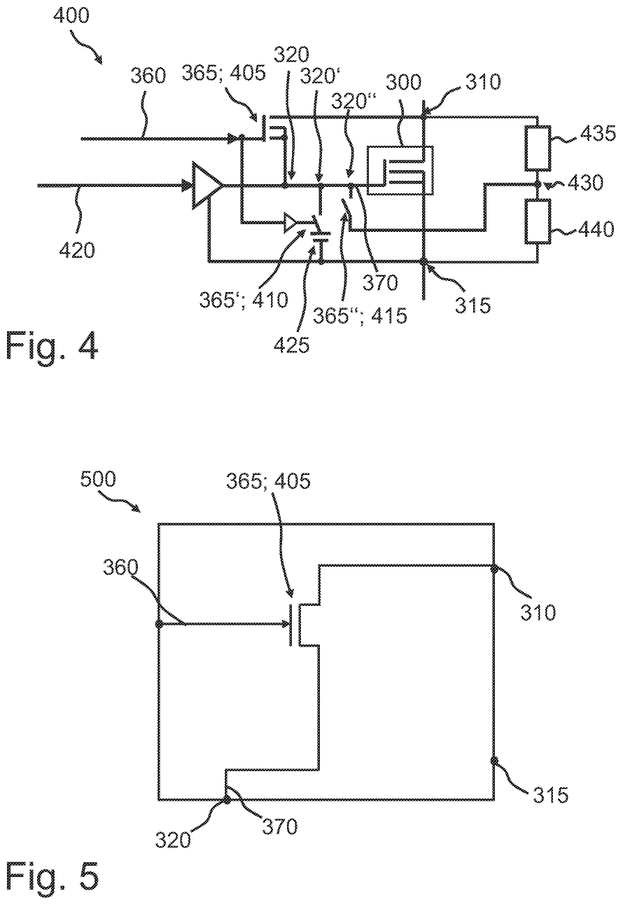

FIG. 4 shows a schematic view of an exemplary embodiment of a circuit 400 for a switch unit 300. The switch unit 300 is designed here with only one switch in the interests of clarity, but a plurality of parallel-connected switches as described with reference to FIG. 3 are actually used for the operation of this switch unit 300. In terms of its function, however, the switch unit 300 itself resembles the switch unit 300 described in FIG. 3 and is implementable accordingly as part of a switch device as described, for example, in FIG. 2. Alternatively, the circuit 400 is also implementable with a plurality of switch units 300.

Here also, for example, at least the one switch is closed using the fault protection signal 360 in order, for example, to divert a current within the circuit 400 to the control connection 320, 320′, 320″. The fault protection switch 365 is implemented, for example, in a plurality of sub-switches as the semiconductor switch 405, as the fault protection switch 365′, as the support switch 410, and the fault protection switch 365″ is implemented as the voltage predefinition switch 415. According to this exemplary embodiment, the fault protection signal 360 is superimposed, for example, on a normal operating signal 420 if a fault state is present. In this case, the switches of the switch unit would then, for example, be transferred to a closed state or would be kept in such a state, even if, according to the normal operating signal 420, the switches should actually be kept in an opened state or transferred to such a state. According to this exemplary embodiment, the semiconductor switch 405 is connected between the first connection 310 and the control connection 320 so that, for example, a voltage present at the first connection 310 is applied to a voltage at the control connection 320. The support switch 410 is further connected between the control connection 320′ and the second connection 315 having an energy source 425. The voltage predefinition switch 415 is only optionally connected between the control connection 320″ and an intermediate tapping point 430 of a voltage divider 435 connected between the first connection 310 and the second connection 315. According to this exemplary embodiment, a further voltage divider 440 is also arranged in the circuit 400. The voltage dividers 435, 440 are designed, for example, to keep a voltage as constant as possible. This means that sudden voltage jumps and/or voltage drops are avoided by using voltage dividers.

In other words, a protection mechanism for semiconductor chips in the event of a fault with an additional loss of activatability is presented by means of the described approach. During the occurrence of a fault, including a loss of control, the drain potential, for example, i.e. a voltage present at the first connection 310 with the gate signal described as the switching signal of the semiconductor, i.e. of the switch unit 300, is connected by means of the fault protection signal 360 referable to as the detection signal or desat signal. As a result, the significantly higher drain voltage is applied to the gate potential, i.e. to the voltage present at the control connection 320, 320′, 320″, so that the voltage increases with a determined voltage edge. If the voltage edge reaches a normal threshold voltage of a gate-source path, i.e. a path between the control connection 320, 320′, 320″ and the second connection 315, the switch unit 300 is transferred to a conducting state. Due to its conductivity, the voltage drop over the drain-source path will reach a threshold voltage. The source potential, i.e. the voltage at the second connection 315, will therefore also be increased and a maximum gate-source voltage load will therefore not be exceeded.

Here, in order to avoid discharging exclusively with a threshold voltage—the internal resistance is not optimal here—a voltage supply by means of the energy source 425 is optionally additionally activated in the event of a fault. The option also exists to use the voltage divider 435 in parallel to translate the high voltage (HV) in a stable manner into the required full activation voltage onto the control connection 320′.

Even with a plurality of switch units 300 which, for example, are interconnected in parallel as a topological switch, these switch units, for example, accept a fault current and/or distribute it favorably among a plurality of semiconductors.

If one of the plurality of parallel-connected switches 325 referable to as a chip produces an unwanted short circuit and the gate-source path of this one chip is likewise short-circuited, only the additional energy source 425 would completely break down the required current, which is then continuously drawn, at a rather early stage since the short-circuited gate would draw off the current. The remaining chips would not additionally also be activated. According to this exemplary embodiment, the voltage present on the first connection 310 is therefore switched to the control connection 320, 320′, 320″ and an intermediate circuit provides, for example, sufficient current for it. In addition, this already raises a voltage level from, for example, −4 V in the deactivated state to the threshold level which lies between +3 V and +5 V and at which the “toggling” begins. Due to the size of its capacitance, the energy source 425 then makes the remaining charge carriers available in order to rise more gently from the threshold value to effective through-connection (+15 V) rather than from −4 V to +15 V.

FIG. 5 shows a schematic view of an exemplary embodiment of a circuit 500 for a switch unit. The circuit 500 shown here is presented by way of example as a partial circuit of the circuit described in FIG. 4 in order illustrate an arrangement of the fault protection switch 365 as the semiconductor switch 405. The semiconductor switch 405 is designed accordingly to establish an electrical connection between the first connection 310 and the control connection 320 in response to the fault protection signal 360. This means that the protection signal 370 is provided to the control connection 320. In some instances, a voltage adjustment would also have to be carried out so that the fault protection signal 360 contains no voltages which destroy the control connection of the switch or switches.

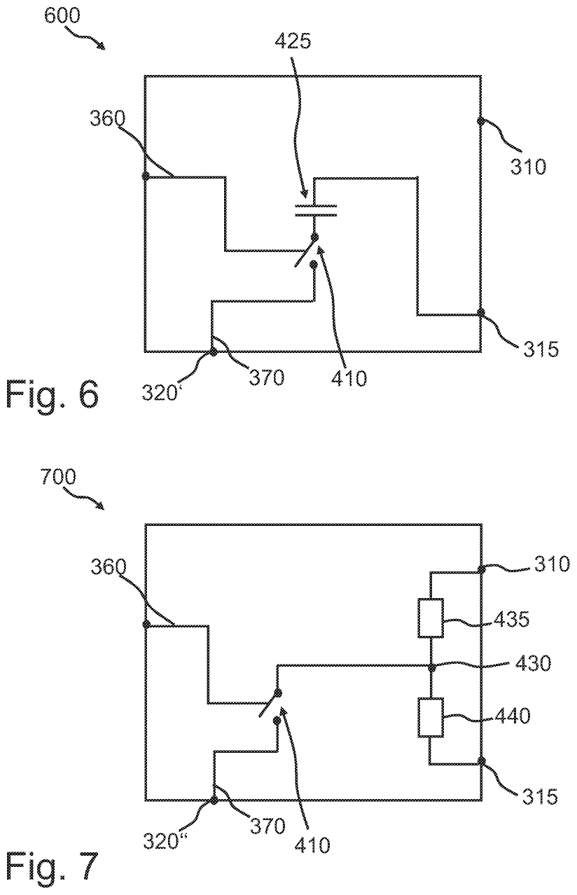

FIG. 6 shows a schematic view of an exemplary embodiment of a circuit 600 for a switch unit having an energy source 425. The circuit 600 shown here is presented by way of example as a partial circuit of the circuit described in FIG. 4 in order to illustrate an arrangement of the fault protection switch 365′ as the support switch 410. The energy source 425 is connected between the support switch 410 and the second connection 315 so that the energy source 425 provides additional energy to the control connection 320′ following the closure of the support switch 410 using the fault protection signal 360. In some instances, a voltage adjustment would likewise also have to be carried out so that the fault protection signal 360 contains no voltages which destroy the control connection of the switch or switches.

FIG. 7 shows a schematic view of an exemplary embodiment of a circuit 700 for a switch unit having at least one voltage divider 435. According to this exemplary embodiment, the circuit 700 additionally has a further voltage divider 440. An individual tapping point 430 which is connected to the fault protection switch 365″ as the voltage predefinition switch 415 is arranged between the two voltage dividers 435, 440. The voltage dividers 435, 440 are further arranged between the first connection 310 and the second connection 315. In some instances, a voltage adjustment would likewise also have to be carried out so that the fault protection signal 360 contains no voltages which destroy the control connection of the switch or switches.

According to this exemplary embodiment, the voltage predefinition switch 415 is arranged between the intermediate tapping point 430 and the control connection 320″. As a result of this position of the voltage predefinition switch 415 and the connection to the voltage divider 435, the voltage, for example, does not suddenly decrease substantially when the voltage predefinition switch 415 is closed.

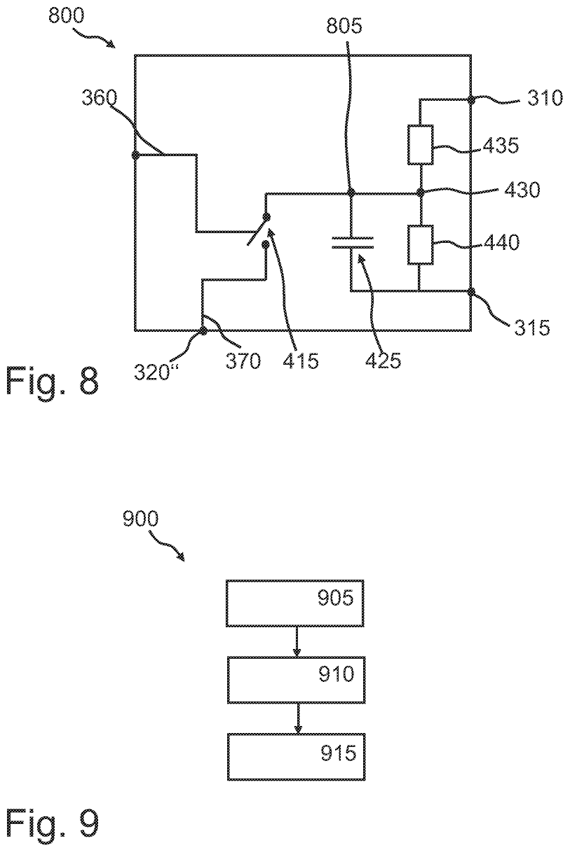

FIG. 8 shows a schematic view of an exemplary embodiment of a circuit 800 for a switch unit having at least one voltage divider 435. The circuit 800 shown here is presented by way of example as a partial circuit of the circuit described in FIG. 4 and resembles, for example, the circuit described in FIG. 7. According to this exemplary embodiment, the circuit 800 additionally has only an energy source 425, which is connected between a connection point 805 and the second connection 315. According to this exemplary embodiment, the voltage predefinition switch 415 is arranged between the connection point 805 and the control connection 320″. As a result, the energy source 425 functions, for example, as a booster so that a voltage value represents a predefined value or lies within a tolerance range around the predefined value, insofar as the voltage predefinition switch 415 has been closed in response to the fault protection signal 360. In some instances, a voltage adjustment would likewise also have to be carried out so that the fault protection signal 360 contains no voltages which destroy the control connection of the switch or switches.

FIG. 9 shows a flow diagram of an exemplary embodiment of a method 900 for operating a switch device having a switch unit. The switch unit has a first connection, a second connection, a control connection and a plurality of switches connected between the first connection and the second connection which are jointly activated or activatable by the control connection. The method 900 is carried out and/or activated, for example, for a switch device as described in at least one of FIGS. 2 to 3, and can be carried out accordingly by a control unit as described, for example, in FIG. 3.

For this purpose, the method 900 comprises a read-in step 905, a determining step 910 and a providing step 915. In the read-in step 905, a measurement signal is read via an interface into a measuring unit. The measurement signal represents an actual parameter of the switch unit. In the determining step 910, a fault state of the switch unit is determined if the actual parameter is in a predetermined relationship with a predefined target parameter. In the providing step 915, a fault protection signal is determined in response to the determined fault state, wherein the fault protection signal is designed to activate at least one fault protection switch and thereby apply a protection signal to the control connection, by which the switches are closed or kept closed. A switchover of the switch unit, for example, from an operating mode to a conducting mode and therefore to a passive conductor is thereby effected.

According to this exemplary embodiment, the actual parameter is read in as a voltage between the first and second connection and, in the determining step 910, the fault state is determined if the voltage is less than a predefined target voltage. Additionally or alternatively, in the step 905 of reading in as an actual parameter, a current can be read in by means of the first connection and, in the determining step 910, the fault state is determined if the current is greater than a predefined target current. The actual parameter is further read in, for example, as a parameter representing a temperature of one of the switches and, in the determining step 910, the fault state is determined if the temperature is greater than a predefined target temperature. For this purpose, for example, a comparison is carried out in the determining step 910.

Furthermore, in the providing step 915, the fault protection signal is optionally provided to a semiconductor switch between the first connection and the control connection in order to close the semiconductor switch in the fault state. Additionally or alternatively, the fault protection signal is provided to a support switch between the control connection and an energy source coupled to the second connection and/or to a voltage predefinition switch between the control connection and an intermediate tapping point of a voltage divider connected between the first and second connection. The energy source is activated, for example, in order to keep the voltage value at the control connection continuously above a limit value so that the switch unit remains in a conducting mode and does not flip over if the value is understepped. Furthermore, the fault protection signal is optionally provided to the voltage predefinition switch, wherein the voltage predefinition switch is further connected between the control connection and a connection point. The energy source is connected, for example, between the connection point and the second connection. In each of these cases, in the providing step 915, the fault protection signal is, for example, superimposed on a signal at the control connection and/or is impressed on the control connection. The control connection is designed to activate a switching procedure of the switches of the switch unit in a normal operating state which excludes, for example, the fault state.

In other words, as a result of the presented approach and the method 900, for semiconductor chips, power modules or power switches, for example, which are used or referred to here as switch units, an overloading of the one defective switch is avoided in the event of a fault, such as, for example, an unwanted short circuit, through the closure of a plurality of parallel-connected switches, and the switches of the switch device are therefore switched to a safe state, even if, for example, individual switches are defective and not activatable.

The exemplary embodiments described and shown in figures are chosen only by way of example. Different exemplary embodiments can be combined with one another completely or in respect of individual features. One exemplary embodiment can also be supplemented by features of a further exemplary embodiment.

Method steps according to the present disclosure can further be repeated and executed in a sequence other than the sequence described.

If an exemplary embodiment comprises an “and/or” link between a first feature and a second feature, this can be read in such a way that the exemplary embodiment according to one embodiment has both the first feature and the second feature and, according to a further embodiment, has either the first feature only or the second feature only.

### Reference Signs

100 Vehicle
105 Electrical final drive
110 Energy supply device
115 Electric machine
120 Drive device
125 Power converter
200 Control device
205 Switch device
210 Electrical lines
300 Switch unit
305 Control unit
310 First connection
315 Second connection
320 Control connection
320′ Control connection
320″ Control connection
325 Switch
335 Read-in unit
340 Determining unit
345 Providing unit
350 Measurement signal
355 Measuring unit
360 Fault protection signal
365 Fault protection switch
365′ Fault protection switch
365″ Fault protection switch
370 Protection signal
400 Circuit
405 Semiconductor switch
410 Support switch
415 Voltage predefinition switch
420 Normal operating signal
425 Energy source
430 Intermediate tapping point
435 Voltage divider
440 Further voltage divider
500 Circuit
600 Circuit
700 Circuit
800 Circuit
900 Method for operating a switch device
905 Read-in step
910 Determining step
915 Providing step

1. A method for operating a switch device having a switch unit having a first connection, a second connection, a control connection, and a plurality of switches connected between the first connection and the second connection which are jointly activated by the control connection, the method comprising:
reading a measurement signal via an interface into a measuring unit, wherein the measurement signal represents an actual parameter of the switch unit;
determining a fault state of the switch unit in response to the actual parameter being in a predetermined relationship with a predefined target parameter; and
providing a fault protection signal in response to the determined fault state, wherein the fault protection signal is configured to activate at least one fault protection switch and thereby apply a protection signal to the control connection, by which the switches are closed or kept closed.

2. The method according to claim 1,
wherein reading the measurement signal into the measurement unit as an actual parameter comprises reading in a voltage between the first connection and the second connection, and
wherein determining the fault state comprises determining that the voltage is less than a predefined target voltage.

3. The method according to claim 1,
wherein reading the measurement signal into the measurement unit as an actual parameter comprises reading in a current by the first connection, and
wherein determining the fault state comprises determining that the current is greater than a predefined target current.

4. The method according to claim 1,
wherein reading the measurement signal into the measurement unit as an actual parameter comprises reading in a parameter representing a temperature of at least one of the switches, and
wherein determining the fault state comprises determining that the temperature is greater than a predefined target temperature.

5. The method according to claim 1, comprising:
providing the fault protection signal to a semiconductor switch between the first connection and the control connection in order to close the semiconductor switch in the fault state.

6. The method according to claim 1, comprising:
providing the fault protection signal to a support switch between the control connection and an energy source coupled to the second connection.

7. The method according to claim 1, comprising:
providing the fault protection signal to a voltage predefinition switch between the control connection and an intermediate tapping point of a voltage divider connected between the first connection and the second connection.

8. The method according to claim 7,
wherein the voltage predefinition switch is further connected between the control connection and a connection point, wherein an energy source is connected between the connection point and the second connection.

9. The method according to claim 1, comprising:
superimposing and/or impressing the fault protection signal on the control connection, wherein the control connection is configured to activate a switching procedure of the switches of the switch unit in a normal operating state.

10. A non-transitory machine-readable storage medium, having stored thereon, a computer program that, when executed by at least one processing device, cause the at least one processing device to perform a method comprising:
reading a measurement signal via an interface into a measuring unit, wherein the measurement signal represents an actual parameter of a switch unit, wherein the switch unit comprises a first connection, a second connection, a control connection, and a plurality of switches connected between the first connection and the second connection which are jointly activated by the control connection;
determining a fault state of the switch unit in response to the actual parameter being in a predetermined relationship with a predefined target parameter; and
providing a fault protection signal in response to the determined fault state, wherein the fault protection signal is configured to activate at least one fault protection switch and thereby apply a protection signal to the control connection, by which the switches are closed or kept closed.

11. A controller for a switch unit, wherein the switch unit comprises a first connection, a second connection, a control connection, and a plurality of switches connected between the first connection and the second connection which are jointly activated by the control connection, wherein the controller is configured to:
read a measurement signal via an interface into a measuring unit, wherein the measurement signal represents an actual parameter of a switch unit;
determine a fault state of the switch unit in response to the actual parameter being in a predetermined relationship with a predefined target parameter; and
provide a fault protection signal in response to the determined fault state, wherein the fault protection signal is configured to activate at least one fault protection switch and thereby apply a protection signal to the control connection, by which the switches are closed or kept closed.

12. A switch device comprising:
the controller according to claim 11; and
a switch unit, wherein the switch unit comprises:
a first connection, a second connection, a control connection, and a plurality of switches which are connected between the first connection and the second connection and which are jointly activated by the control connection,
wherein the controller is configured to activate the control connection of the switches of the switch unit with the fault protection signal.

13. The switch device according to claim 12, wherein the switches of the switch unit are configured as power electronics components comprising semiconductor switching elements.

14. A power converter comprising the switch device according to claim 12.

15. An electrical final drive for a motor vehicle comprising:
at least one electric machine;
a drive device; and
the power converter according to claim 14.

16. A motor vehicle comprising:
the switch device according to claim 12.

17. The controller according to claim 11, wherein the controller is configured to:
read the measurement signal into the measurement unit as an actual parameter by reading in a voltage between the first connection and the second connection; and
determine the fault state by determining that the voltage is less than a predefined target voltage.

18. The controller according to claim 11, wherein the controller is configured to:
read the measurement signal into the measurement unit as an actual parameter by reading in a current by the first connection; and
determine the fault state by determining that the current is greater than a predefined target current.

19. The controller according to claim 11, wherein the controller is configured to:
read the measurement signal into the measurement unit as an actual parameter by reading in a parameter representing a temperature of at least one of the switches; and
determine the fault state by determining that the temperature is greater than a predefined target temperature.

20. The controller according to claim 11, wherein the controller is configured to:
provide the fault protection signal to a semiconductor switch between the first connection and the control connection in order to close the semiconductor switch in the fault state.
